(19) United States
(12) Patent Application Publication
(10) Pub. No.: US 2010/0029853 A1
(43) Pub. Date: Feb. 4, 2010

(54) Controlled architecture copolymers prepared from vinyl phosphonate monomers

(75) Inventor: Mathias Destarac, Paris (FR)

Correspondence Address: BUCHANAN, INGERSOLL & ROONEY PC, POST OFFICE BOX 1404, ALEXANDRIA, VA, 22313-1404, US

(73) Assignee: Rhodia Receherches et Technologies, Aubervilliers (FR)

(21) Appl. No.: 11/920,837

(22) PCT Filed: May 18, 2006
(86) PCT No.: PCT/FR2006/001121

§ 371 Date: Aug. 6, 2009

(30) Foreign Application Priority Data
May 23, 2005 (FR) 0505133
Dec. 21, 2005 (FR) 0513032

(51) Int. Cl. C08F 293/00

(52) U.S. Cl. 525/199; 525/209; 525/203

(57) ABSTRACT

Controlled architecture copolymers comprise at least one block A obtained by polymerizing a mixture of ethylenically unsaturated monomers (A₀) not including vinyl phosphonate monomers and at least one block B obtained by polymerizing a mixture of ethylenically unsaturated monomers (B₀) including at least 50 mol % of at least one monomer B₁ bearing at least one vinyl phosphonate function.

A subject matter of the present invention is a controlled architecture copolymer comprising at least one block A obtained by the polymerization of a mixture of monomers possessing ethylenic unsaturation (A₀) not comprising monomers possessing vinylphosphonate functional groups and at least one block B obtained by the polymerization of a mixture of monomers possessing ethylenic unsaturation (B₀) comprising at least 50 mol % of at least one monomer B₁ carrying at least one vinylphosphonate functional group.

Another subject matter of the present invention is a process for the synthesis of a controlled architecture copolymer comprising at least one block A obtained by the polymerization of a mixture of monomers possessing ethylenic unsaturation (A₀) not comprising monomers possessing vinylphosphonate functional groups and at least one block B obtained by the polymerization of a mixture of monomers possessing ethylenic unsaturation (B₀) comprising at least 50 mol % of at least one monomer B₁ carrying at least one vinylphosphonate functional group.

Another subject matter of the present invention is the use of the copolymer thus obtained as scale inhibitor, as dispersant, as emulsifier or as surface modifier.

According to the present invention, controlled architecture copolymers denote block copolymers, such as diblock and triblock copolymers, grafted copolymers, star copolymers, microgels or copolymers possessing blocks which are branched comprising a microgel core with a variable and controlled crosslinking density (such as those described in the application by M. Destarac, B. Bavouzet and D. Taton, WO 2004/014535, Rhodia Chimie).

The term “monomer possessing a vinylphosphonate functional group” is understood to mean, within the meaning of the present invention, a monomer which comprises at least one vinylphosphonic acid functional group or an alkyl ester analogue.

Mention may in particular be made, among monomers possessing a vinylphosphonate functional group, of the compounds of following formula (I):

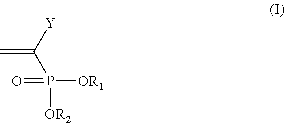

in which:
Y represents a radical chosen from a hydrogen atom, an alkyl radical having from 1 to 6 carbon atoms, a cyano, a phenyl radical, an ester radical of formula —COOR, an acetate radical of formula —OCOR′, a phosphonic acid or a phosphonic acid methyl, ethyl or isopropyl ester;
R and R′, which are identical or different, represent an alkyl radical having from 1 to 12 carbon atoms and preferably an alkyl radical having from 1 to 6 carbon atoms;
R₁ and R₂, which are identical or different, represent a hydrogen atom or an alkyl radical having from 1 to 6 carbon atoms which is optionally substituted by a halogen atom.

The term “halogen atom” is understood to mean chlorine, fluorine, bromine or iodine. Preferably, chlorine is used.

The blocks according to the invention can be homopolymers, random copolymers, alternating copolymers or composition gradient copolymers.

One of the technological approaches of choice which makes it possible to synthesize controlled architecture copolymers is “living” or controlled radical polymerization.

Controlled architecture copolymers are of use in various industries, in particular as dispersing, emulsifying, texturing or surface-modifying agents.

Furthermore, (co)polymers carrying phosphonic acid functional groups are being deployed industrially for their specific functions in varied fields, such as scale inhibitors, corrosion inhibitors or pigment dispersants.

Thus, it is apparent that the synthesis of copolymers possessing complex architectures carrying phosphonate functional groups PO₃R₁R₂ and in particular phosphonic acid functional groups PO₃H₂ represents a very important industrial challenge.

It is also a major technical challenge to be taken up, for two main reasons,
first of all, the range of industrial monomers carrying a phosphonate functional group PO₃R₁R₂ is very limited. The majority are vinyl monomers, such as vinylphosphonic acid, the dimethyl ester of vinylphosphonic acid, the bis(2-chloroethyl) ester of vinylphosphonic acid, vinylidenediphosphonic acid or the tetraisopropyl ester of vinylidenediphosphonic acid;
their low reactivity combined with the phosphonic acid or phosphonate functionality of some of the monomers listed has always greatly compromised their use in a “living” or controlled radical polymerization process.

This is the reason why, to date, the synthesis of homopolymers or copolymers comprising monomers comprising phosphonate functional groups has been carried out by a conventional radical route, that is to say by an uncontrolled mechanism.

The phosphonic acid functional groups PO₃H₂ are often generated by the hydrolysis of the corresponding esters, which can be introduced by an appropriate monomer [Boutevin, B. et al., Polym. Bull., 1993, 30, 243] or an appropriate transfer agent [Boutevin, B. et al., Macromol. Chem. Phys., 2002, 203, 1049] during the polymerization.

Very few studies deal with the direct incorporation of PO₃H₂ functional groups into polymers. This is, for example, the case in the polymerization of vinylphosphonic acid, hereinafter denoted by VPA, by radical initiation [Herwig, W; Duersch, W; Engelhardt, F. U.S. Pat. No. 4,696,987] or by random copolymerization, for example with methacrylic acid [Riegel, U; Gohla, W; Grosse, J; Engelhardt, F; U.S. Pat. No. 4,749,758]. The document GB 2 293 605 describes the polymerization of VPA and its random copolymerization with acrylic acid. Likewise, R. Padda et al. [Phosphorus, Sulfur and Silicon and the Related Elements, 2002, 177 (6-7), 1697] describe the random copolymerization of a diphosphonic monomer: vinylidenediphosphonic acid. As regards telomers, that is to say polymers possessing a controlled chain ending, which are functionalized by PO₃H₂, Rhodia has developed a technology which makes it possible to synthesize polymers (for example, polyacrylic acid (PAA)) possessing a diphosphonic acid di(PO₃H₂) end unit [Davis et al., WO 2004 /078662].

It is apparent that the polymers possessing phosphonate or phosphonic acid functional groups most commonly described are homopolymers, random copolymers, indeed even telomers functionalized with phosphonic acid at their end, these polymers being obtained by a conventional radical route, that is to say by an uncontrolled mechanism.

Mention may be made, among the main “living” or controlled radical polymerization techniques, of atom transfer radical polymerization (ATRP), radical polymerization controlled by stable radicals of nitroxyl type (NMP), iodine degenerative transfer polymerization (ITP) and reversible addition-fragmentation transfer (RAFT) polymerization.

The phosphonic acid units and the ester analogues of the vinyl monomers and/or of the polymers formed have a tendency to strongly interact with the ATRP catalysts (Cu, Ru, Fe, Ni), which compromises the control of this polymerization.

The low level of stabilization of the radicals resulting from vinylphosphonic acid monomers or their ester analogues renders the polymerization of these monomers compatible with difficulty with the technique for radical polymerization controlled by stable radicals of “nitroxyl” type.

In the case where the polymerization is of RAFT type and in particular when the RAFT transfer agent is a xanthate, which process is then referred to as a MADIX process, for Macromolecular Design via the Interchange of Xanthates, VPA was copolymerized randomly with acrylic acid. P(acrylamide)-b-P(AA-stat-VPA) hydrophilic double copolymers have been synthesized as described in the document by M. Destarac and D. Taton, “Direct Access to Phosphonic Acid-Containing Block Copolymers via MADIX”, 40th International Symposium on Macromolecules, MACRO 2004, Paris. P(BuA)-b-P(AA-stat-VPA) amphiphilic copolymers have been synthesized as described in the documents WO 2003/076529 and WO 2003/076531.

However, it is important to note that, in all the cases of MADIX polymerization described above, the degree of incorporation of the VPA in a block did not exceed 25 mol %.

The need existed to succeed in synthesizing block polymers, one of the blocks of which has a composition high in monomer possessing a vinylphosphonate functional group.

This is because the vinylphosphonate monomer is a relatively unreactive monomer which is generally much more expensive than the comonomers which accompany it in the reaction mixture. The fact of being capable of localizing it at will in a specific part of the polymer should make it possible to use less thereof in order to achieve the targeted property and thus to reduce the costs.

Furthermore, the fact of having several consecutive vinylphosphonate units in a polymer should make it possible to introduce advantageous properties, in particular when the polymers thus obtained are used as scale inhibitors.

One the aims of the present invention is to find a means of synthesizing controlled architecture copolymers comprising at least one block based on monomers carrying vinylphosphonate functional groups with a high composition of vinylphosphonate functional groups.

This aim and others have been achieved by the Applicant Company using a specific controlled radical polymerization process of RAFT type. This is because it is by virtue of the control of the reaction conditions, in terms of concentration of the reaction medium, and the conditions of temperature and of concentration of initiator and of thiocarbonylthio control agent RS(C═S)Z that the Applicant Company has been able to solve the problems mentioned above.

A subject matter of the present invention is a controlled architecture copolymer comprising at least one block A obtained by the polymerization of a mixture of monomers possessing ethylenic unsaturation (A₀) not comprising monomers possessing vinylphosphonate functional groups and at least one block B obtained by the polymerization of a mixture of monomers possessing ethylenic unsaturation (B₀) comprising at least 50 mol % of at least one monomer B₁ carrying at least one vinylphosphonate functional group.

Another subject matter of the present invention is a process for the synthesis of a controlled architecture copolymer comprising at least one block A obtained by the polymerization of a mixture of monomers possessing ethylenic unsaturation (A₀) not comprising monomers possessing vinylphosphonate functional groups and at least one block B obtained by the polymerization of a mixture of monomers possessing ethylenic unsaturation (B₀) comprising at least 50 mol % of at least one monomer B₁ carrying at least one vinylphosphonate functional group.

Another subject matter of the present invention is the use of the copolymer thus obtained as scale inhibitor, as dispersant, as emulsifier or as surface modifier.

The controlled architecture copolymer of the invention can be a block (di- or triblock) copolymer, a grafted copolymer, a star copolymer or a microgel comprising at least one block A and at least one block B.

The block A according to the invention is obtained by the polymerization of a mixture of monomers possessing ethylenic unsaturation (A₀) not comprising monomers possessing vinylphosphonate functional groups. The block B is obtained by the polymerization of a mixture of monomers possessing ethylenic unsaturation (B₀) comprising at least 50 mol % of at least one monomer B₁ carrying a vinylphosphonate functional group.

The blocks according to the invention can be homopolymers, random copolymers, alternating copolymers or composition gradient copolymers.

According to the invention, the ratio by weight of the blocks A and B varies between 1/99 and 99/1.

The block A is obtained by the polymerization of a mixture of monomers (A₀) possessing ethylenic unsaturation not comprising monomers carrying a vinylphosphonate functional group. The group (A₀) comprises the hydrophilic (h) or hydrophobic (H) monomers chosen from the following monomers: mention may be made, among the hydrophilic (h) monomers, of:
unsaturated ethylenic mono- and dicarboxylic acids, such as acrylic acid, methacrylic acid, itaconic acid, maleic acid or fumaric acid, and their derivatives, such as monoalkyl esters, preferably with C₁-C₄ alcohols, and amides, such as acrylamide or methacrylamide, or
ethylenic monomers comprising a ureido group, such as ethylene urea ethyl methacrylamide or ethylene urea ethyl methacrylate, or
ethylenic monomers comprising a sulfonic acid group or one of its alkali metal or ammonium salts, such as, for example, vinylsulfonic acid, vinylbenzenesulfonic acid, α-acrylamidomethylpropanesulfonic acid or 2-sulfoethylene methacrylate, or
monomers carrying a boronic acid functional group, such as p-vinylphenylboronic acid, or
cationic monomers chosen from aminoalkyl(meth)acrylates or aminoalkyl(meth)acrylamides; monomers comprising at least one secondary, tertiary or quaternary amine functional group or a heterocyclic group comprising a nitrogen atom; diallyldialkyl ammonium salts; these monomers being taken alone or as mixtures, and also in the form of salts, the salts preferably being chosen so that the counterion is a halide, such as, for example, a chloride, or a sulfate, a hydrogen sulfate, an alkyl sulfate (for example comprising 1 to 6 carbon atoms), a phosphate, a citrate, a formate, an acetate, such as dimethylamino-ethyl(meth)acrylate, dimethylaminopropyl(meth)-acrylate, di(tert-butyl)aminoethyl(meth)acrylate, dimethylaminomethyl(meth)acrylamide, dimethylamino-propyl(meth)acrylamide; ethylenimine, vinylamine, 2-vinylpyridine, 4-vinylpyridine; trimethylammonioethyl (meth)acrylate chloride, trimethylammonioethyl acrylate methyl sulfate, benzyldimethylammonioethyl(meth)-acrylate chloride, (4-benzoylbenzyl)dimethylammonio-ethyl acrylate chloride, trimethylammonioethyl(meth)-acrylamide chloride, trimethyl(vinylbenzyl)ammonium chloride, diallyldimethylammonium chloride, alone or as mixtures, or their corresponding salts, or
cyclic amides of vinylamine, such as N-vinylpyrrolidone and vinylcaprolactam, or
the polyvinyl alcohol resulting from the hydrolysis of a polyvinyl acetate, for example, or
more generally, hydrophilic polymers resulting from the chemical modification of a hydrophobic block, for example by hydrolysis of a polyalkyl acrylate to give a polyacrylic acid.

Preferably, the hydrophilic (h) monomer units are chosen from acrylic acid (AA), acrylamide (Am), 2-acrylamido-2-methylpropanesulfonic acid (AMPS), styrenesulfonate (SS), N-vinylpyrrolidone, vinyl-sulfonic acid (VSA), or their mixtures, and vinyl alcohol units resulting from the hydrolysis of polyvinyl acetate, or their mixtures.

More preferably still, acrylic acid (AA) or acrylamide (Am) units are used.

Mention may be made, among monomers having a hydrophobic (H) nature, of:
monomers derived from styrene, such as styrene, α-methylstyrene, para-methylstyrene or para-(tert-butyl)styrene, or
esters of acrylic acid or of methacrylic acid with C₁-C₁₂, preferably C₁-C₈, alcohols which are optionally fluorinated, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,
vinyl nitriles comprising from 3 to 12 carbon atoms, preferably acrylonitrile or methacrylonitrile,
vinyl esters of carboxylic acids, such as vinyl acetate (VAc), vinyl versatate or vinyl propionate,
vinyl or vinylidene halides, for example vinyl chloride, vinylidene chloride and vinylidene fluoride, and
diene monomers, for example butadiene or isoprene.

Preferably, the hydrophobic (H) monomer units of the controlled architecture copolymers of the invention are esters of acrylic acid with linear or branched C₁-C₈, in particular C₁-C₄, alcohols, such as, for example, methyl acrylate, ethyl acrylate, propyl acrylate, butyl acrylate (BuA) or 2-ethylhexyl acrylate (2EHA), fluorinated acrylates, or else styrene derivatives, such as styrene or vinyl acetate (VAc).

According to a preferred form of the invention, the block A is polyacrylic acid or polyvinyl alcohol.

The polyacrylic acid can be obtained either by polymerization of acrylic acid monomer or by polymerization of a monomer of alkyl acrylate type, such as, for example, methyl or butyl acrylate, followed by a hydrolysis.

The polyvinyl alcohol can be obtained by polymerization of vinyl acetate, followed by a hydrolysis.

With regard to the block B, it is obtained by the polymerization of a mixture of monomers (B₀) comprising:
from 50 to 100 mol % of at least one monomer B₁ carrying at least one vinylphosphonate functional group, and
from 0 to 50 mol % of at least one monomer B₂ not carrying a vinylphosphonate functional group chosen from the group A₀ defined above.

The monomer comprising at least one vinylphosphonate functional group B₁ can be a compound of formula (I):

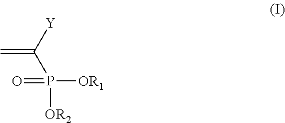

in which:
Y represents a radical chosen from a hydrogen atom, an alkyl radical having from 1 to 6 carbon atoms, a cyano, a phenyl radical, an ester radical of formula —COOR, an acetate radical of formula —OCOR′, a phosphonic acid or a phosphonic acid methyl, ethyl or isopropyl ester;
R and R′, which are identical or different, represent an alkyl radical having from 1 to 12 carbon atoms and preferably an alkyl radical having from 1 to 6 carbon atoms;
R₁ and R₂, which are identical or different, represent a hydrogen atom or an alkyl radical having from 1 to 6 carbon atoms which is optionally substituted by a halogen atom;
   or their mixtures,
   it being understood that, when Y is other than a hydrogen atom, then the block B also comprises monomers B₁ in which Y represents a hydrogen atom.

The term “halogen atom” is understood to mean chlorine, fluorine, bromine or iodine. Preferably, chlorine is used.

Mention may in particular be made, among the monomers B₁ of use in the present invention, of vinylphosphonic acid, the dimethyl ester of vinylphosphonic acid, the bis(2-chloroethyl) ester of vinylphosphonic acid, vinylidenediphosphonic acid, the tetraisopropyl ester of vinylidenediphosphonic acid or α-styrenephosphonic acid, or their mixtures.

The monomers B₁ possessing one or two vinylphosphonic acid functional group(s) can be used in the free acid form or in the form of their salts. They can be partially or completely neutralized, optionally by an amine, for example dicyclohexylamine.

The preferred monomer B₁ according to the invention is vinylphosphonic acid.

The monomer B₂ of use in the present invention can be chosen from the monomers A₀ defined above.

Preferably, the monomer B₂ is chosen from acrylic acid, acrylamide, vinylsulfonic acid or their mixtures.

More preferably still, the monomer B₂ is acrylic acid.

Generally, the controlled architecture copolymers of the invention exhibit a weight-average molecular weight of between 1000 and 100 000, generally between 4000 and 50 000. They also exhibit a polydispersity index of less than 2.5, preferably of between 1.3 and 2.5 and more preferably between 1.3 and 2.0.

The ratio by weight of block A to block B is such that B/(A+B) is preferably between 0.01 and 0.5 and more preferably still between 0.02 and 0.2.

Another subject matter of the present invention is a process for the synthesis of a controlled architecture copolymer comprising at least one block A obtained by the polymerization of a mixture of monomers possessing ethylenic unsaturation (A₀) not comprising monomers possessing vinylphosphonate functional groups and at least one block B obtained by the polymerization of a mixture of monomers possessing ethylenic unsaturation (B₀) comprising at least 50 mol % of at least one monomer B₁ carrying at least one vinylphosphonate functional group comprising the following stages:
(a) a controlled radical polymerization is carried out, resulting in the production of a functionalized polymer of use as control agent in a controlled radical polymerization reaction, said stage being carried out by bringing into contact:
   ethylenically unsaturated monomer molecules,
   a source of free radicals, and
   at least one control agent;
(b) following stage (a), a stage of controlled radical polymerization or several successive stages of controlled radical polymerizations is/are carried out, said stage(s) each consisting in carrying out a controlled radical polymerization resulting in the production of a functionalized block copolymer of use as control agent in a controlled radical polymerization reaction, said stage or stages being carried out by bringing into contact:
   ethylenically unsaturated monomer molecules different from those employed in the preceding stage,
   a source of free radicals, and
   the functionalized polymer resulting from the preceding stage,
      it being understood that one of the polymerization stages (a) and (b) defined above results in the formation of the block B, that is to say of the block comprising the vinylphosphonate functional groups, and that another of the polymerization stages of stages (a) and (b) results in the formation of another block, in this case block A, the ethylenically unsaturated monomers employed in stages (a) and (b) being chosen from the appropriate monomers in order to obtain a controlled architecture copolymer as defined above, characterized in that:
      the concentration of monomer B₀ in the medium is such that the level of solid has to be greater than 50%, preferably greater than 60% and more preferably still greater than 70%, the level of solid being defined in the following way:
      weight B₀/weight (B₀+solvent), if B₀ is polymerized as first block,
      weight (A₀+B₀)/weight (A₀+B₀+solvent) , if B₀ is polymerized as second block; and
      the cumulative or total concentration of the initiator is between 0.5 and 20 mol % with respect to the mixture of monomers B₀.

It is specified that the term “ethylenically unsaturated monomer molecules different from those employed during the preceding stage” is understood to mean that at least one monomer molecule is different from those employed during the preceding stage. In other words, if, during stage(s) (b), a mixture of monomers is employed, it is sufficient for this mixture to comprise at least one monomer different from the monomer or monomers employed during the preceding stage. According to one embodiment, all the monomers of stage(s) (b) are different from those employed during the preceding stage.

The molecular weights of the block B are generally less than 10 000, preferably less than 5000 and more preferably still less than 2000.

The concentration of initiator and the method of introducing the initiator are defined so as to obtain a good compromise between a high conversion of monomer B₀ and a level of uncontrolled chains which is as low as possible.

Thus, the initiator is introduced as a batch at the beginning of the reaction, or spotwise or continuously or semicontinuously, the monomer B₁ preferably being put in the vessel heel so that the cumulative or total concentration of the initiator is between 0.5 and 20 mol % with respect to the mixture of monomers B₀.

The level of monomer B₀ solid is high in comparison with the usual conditions under which controlled radical polymerization processes are carried out.

Finally, the molecular weights of the block B have also been defined so as to satisfactorily control the polymerization.

The control agent of use in carrying out the process of the invention can be chosen from thiocarbonylthio compounds RS(C═S)Z.

The control agent of use in carrying out the process of the invention can be chosen from dithioesters, thioethers-thiones, trithiocarbonates, dithio-carbamates, including N,N-dialkyldithiocarbamates, dithiocarbazates and xanthates.

Use is preferably made, as control agent, of a compound chosen from N,N-dialkyldithiocarbamates, dithio-carbazates and xanthates.

More preferably still, use is made, as control agent, of a compound chosen from xanthates.

Xanthates are compounds of following formula (II):

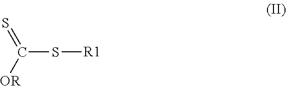

in which:
R represents:
   H or Cl;
   an alkyl, aryl, alkenyl or alkynyl group;
   a saturated or unsaturated, optionally aromatic, carbon ring;
   a saturated or unsaturated, optionally aromatic, heterocycle;
   an alkylthio group;
   an alkoxycarbonyl, aryloxycarbonyl, carboxyl, acyloxy or carbamoyl group;
   a cyano, dialkyl- or diarylphosphonato, or dialkyl- or diarylphosphinato group;
   a polymer chain;
   an (R₂)O— or (R₂)(R′₂)N— group in which the R₂ and R′₂ radicals, which are identical or different, each represent:
   an alkyl, acyl, aryl, alkenyl or alkynyl group;
   a saturated or unsaturated, optionally aromatic, carbon ring; or
   a saturated or unsaturated, optionally aromatic, heterocycle;
      and
R1 represents:
   an alkyl, acyl, aryl, alkenyl or alkyhyl group;
   a saturated or unsaturated, optionally aromatic, carbon ring;
   a saturated or unsaturated, optionally aromatic, heterocycle; or
   a polymer chain;
      one of the control agents which is particularly advantageous is a compound of formula (II) in which R represents an ethyl radical and R1 represents a (methoxycarbonyl)ethyl radical.

The polymerization can be carried out in particular under bulk conditions, in a solvent or else in a dispersed medium.

When the polymerization is carried out in a solvent, said solvent is ethyl acetate or an alcohol chosen from ethanol, isopropanol, or their mixtures with water, if appropriate.

The polymerization carried out in aqueous or aqueous/alcoholic solution constitutes a preferred embodiment of the invention.

Water, an alcohol or an aqueous/alcoholic medium are more particularly recommended in the context of the use of hydrophilic monomers of the acrylic acid (AA), acrylamide (Am), 2-acrylamido-2-methylpropanesulfonic acid (AMPS) and styrenesulfonate (SS) type and/or in the context of the use of hydrophobic monomers, such as n-butyl acrylate or 2-ethylhexyl acrylate.

The controlled architecture copolymers of the invention are of use in various industries. They can be used in particular as scale inhibitor, dispersant, inorganic surface modifier (glass, metal, ceramic), emulsifier or corrosion inhibitor.

The following examples illustrate the invention without limiting the scope thereof.

### EXAMPLES

Part I. Polymerization of Vinylphosphonic Acid (VPA) by Radical Polymerization Controlled by Xanthates

The polymerization of vinylphosphonic acid (VPA) was carried out in a water/ethanol (85/15 by weight) mixture at 70° C. and was initiated by azobis(cyanopentanoic acid) (ACP), in the presence of O-ethyl S-(1-(methoxycarbonyl)ethyl) xanthate (CH₃CHCO₂CH₃)S(C═S)OEt, hereinafter denoted by X1, this being the case for two initial concentrations of xanthate such that the theoretical DPₙ values at the end of the polymerization are equal to 10 (example 1) and 30 (example 2) respectively. The level of solid targeted at complete conversion of the monomer is 70% in both cases.

A kinetic study of these reactions showed that:
by ³¹P NMR analysis, it appears that the conversion of vinylphosphonic acid (VPA) gradually increases over time, to reach a value of 75% for example 1 and 83% for example 2 after reacting for 18 hours (table 1);
by gas chromatography analysis, it is found that the xanthate is completely consumed in the first phase of polymerization, at the latest after approximately 20% conversion of vinylphosphonic acid (VPA) (table 1).

It is important to note that the rapid consumption of the xanthate is not due mainly to possible chemical decomposition, due to the highly acidic pH of the reaction medium. This can be asserted following a control reaction carried out in the absence of radical initiator (example 3), everything else otherwise being the same as the conditions of example 2. While no polymerization is observed in 18 h, the xanthate has decomposed to the extent of 9% after 2 hours and of 18% after 5 hours. It may be observed that the decomposition of the xanthate at 70° C. in the presence of VPA changes virtually linearly as a function of time (table 1).

TABLE 1
Table 1. Kinetics of polymerization of vinyl-
phosphonic acid (VPA) in the presence of O-ethyl
S-(1-(methoxycarbonyl)ethyl) xanthate X1.

| Ref. | Time (hours) | VPA conversion (%) | X₁ conversion (%) |
|---|---|---|---|
| (example 1) | 5.5 | 43 | 99.8 |
| | 18 | 83 | 99.9 |
| (example 2) | 2 | 21 | 99.9 |
| | 5.5 | 46 | 99.9 |
| | 18 | 75 | 99.9 |
| (example 3) | 2 | 0 | 9 |
| | 5 | 0 | 18 |
| | 18 | 0 | 64 |

These various results allow it to be concluded that the reactivity of the xanthate in the polymerization of vinylphosphonic acid (VPA) is indeed higher than for the polymerizations of the acrylic, acrylamide or styrene monomers.

A GPC analysis provided with a UV detector makes it possible to assess the presence of the xanthate fragment —S(C═S)OEt at the end of the polymer chain for examples 1 and 2. This is because the area under the curve of the GPC/UV chromatogram is more than 100 times more intense for examples 1 and 2 than for a poly(vinylphosphonic acid) P(VPA) synthesized in the absence of xanthate.

DOSY NMR Analysis

The DOSY NMR analysis of the P(VPA)s of examples 1 and 2 makes it possible to assert that the polymers predominantly comprise a population of chains of following formula:

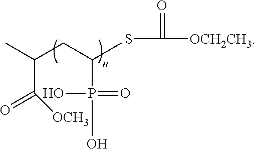

The 2D DOSY NMR analysis of the polymer of example 1 makes it possible to observe the presence of entities with high masses corresponding mainly to the poly(vinylphosphonic acid) with a “living” nature, confirmed by the presence of the xanthate chain ends which are associated with it (OCH₂ of the sulfur-comprising xanthate end).

For the polymer of example 2, the 2D DOSY chart obtained is comparable with that of the poly(vinylphosphonic acid) of example 1; the same types of entities are visualized.

### CONCLUSION

The combined analyses of the polymers by GPC/UV and 2D DOSY NMR, as well as the kinetic monitoring of consumption of the xanthate and of the vinylphosphonic acid (VPA) monomer, make it possible to assert that the MADIX polymerization indeed results in the expected controlled polymers.

### Example 1

40 g of vinylphosphonic acid, 3 g of ethanol, 19.4 g of water and 7.71 g of O-ethyl S-(1-(methoxycarbonyl)-ethyl)xanthate (CH₃CHCO₂CH₃)S(C═S)OEt (X1) are introduced into a 250 ml two-necked round-bottomed glass flask equipped with a magnetic stirrer and a reflux condenser and maintained under argon. The solution is brought to temperature at 70° C. and 5.19 g of azobis(cyanopentanoic acid) are added to the reaction mixture. After 6 hours at this temperature, a further 5.19 g of azobis(cyanopentanoic acid) are added. The reaction is continued for 12 hours. At the end of the reaction, the GC (cf. table 1), ³¹P NMR (cf. table 1), DOSY NMR and GPC analyses are carried out. Measurement of Mₙ is rendered impossible by the presence of residual vinylphosphonic acid (VPA), the chromatographic peak of which is partially superimposed on the distribution of molecular weights.

### Example 2

40 g of vinylphosphonic acid, 3 g of ethanol, 17.5 g of water and 2.57 g of O-ethyl S-(1-(methoxycarbonyl)-ethyl)xanthate (CH₃CHCO₂CH₃)S(C═S)OEt (X1) are introduced into a 250 ml two-necked round-bottomed glass flask equipped with a magnetic stirrer and a reflux condenser and maintained under argon. The solution is brought to temperature at 70° C. and 5.19 g of azobis(cyanopentanoic acid) are added to the reaction mixture. After 6 hours at this temperature, a further 5.19 g of azobis(cyanopentanoic acid) are added. The reaction is continued for 12 hours. At the end of the reaction, the GC (cf. table 1), ³¹P NMR (cf. table 1), DOSY NMR and GPC analyses are carried out. Measurement of Mₙ is rendered impossible by the presence of residual vinylphosphonic acid (VPA), the chromatographic peak of which is partially superimposed on the distribution of molecular weights.

Part II. Synthesis of Diblock Copolymers by MADIX, One of the Blocks of Which is poly(vinylphosphonic acid) P(VPA)

Once the controlled nature of the polymerization of vinylphosphonic acid (VPA) has been confirmed, it is a matter of demonstrating that the synthesis of diblock copolymers is rendered possible by this method.

During our study, it became apparent that the order of synthesis of the two blocks is a key parameter for the purpose of synthesizing the desired diblock polymer. This is illustrated below for the case of the acrylic acid/vinylphosphonic acid (AA/VPA) pair.

It should be noted that the low DPₙ values targeted are deliberately chosen in order to clearly demonstrate the controlled nature of the polymerization by GPC.

### Example 3

poly(vinylphosphonic acid) P(VPA) as First Block:

An oligomer of vinylphosphonic acid (VPA) was synthesized in the presence of O-ethyl S-(1-(methoxy-carbonyl)ethyl)xanthate X₁. The starting concentrations of VPA and xanthate are chosen so the theoretical DPₙ is equal to 5. The reaction is carried out at 70° C. in a water/ethanol (73/27 by weight) mixture at a level of solid of 70% and initiated with azobis(cyanopentanoic acid). After reacting for 18 h, the degree of conversion of vinylphosphonic acid (VPA) is 77% (³¹P NMR). The degree of conversion of the xanthate is 100% (GC). By GPC in water with polyethylene oxide (PEO) calibration, Mₙ=670 g/mol and M_{w}/Mₙ=1.96. The chromatogram obtained by UV detection at 290 nm shows a very intense chromatographic response, characteristic of the presence of the xanthate at the chain end.

Polymerization of AA in the Presence of Xanthate-Terminated poly(vinylphosphonic acid) P(VPA)-X₁:

The amount of acrylic acid is chosen so that the polyacrylic acid (PAA) block comprises on average 20 monomer units, on the assumption that the polymerization will be controlled. The polymerization is carried out at a level of solid at 20%, at 70° C., initiated by azobis(cyanopentanoic acid), the polymerization being carried out for 6 hours. All the acrylic acid is converted (gravimetric measurement). The GPC analysis shows the presence of two populations of polymer: a polymer of high molecular weight, which does not absorb at all under UV light at 290 nm: this is polyacrylic acid (PAA) homopolymer. The other population corresponds to the starting xanthate-terminated poly(vinylphosphonic acid) P(VPA)-X₁.

In other words, the xanthate-terminated poly(vinylphosphonic acid) oligomer P(VPA)-X₁ is a transfer agent which is unreactive in the polymerization of acrylic acid (AA). At the end, a blend of polyacrylic acid (PAA) and poly(vinylphosphonic acid) P(VPA) homopolymers is obtained.

### Example 4

### Synthesis of a polyacrylic acid-b-poly(vinylphosphonic acid) P(AA)-b-P(VPA) Diblock

Polyacrylic Acid P(AA) as First Block

20 g of acrylic acid (AA), 5.79 g of X1, 0.44 g of ACP, 40.8 g of water and 16.2 g of ethanol are heated at 70° C. for 6 hours in a round-bottomed glass flask equipped with reflux condenser and a magnetic stirrer. This results in a polyacrylic acid P(AA) functionalized with xanthate at its end and with a controlled Mₙ, as is demonstrated by the GPC analyses.

Polymerization of Vinylphosphonic Acid (VPA) in the Presence of Xanthate-Terminated Polyacrylic Acid P(AA)-X

The amount of vinylphosphonic acid (VPA) is chosen so that the poly(vinylphosphonic acid) P(VPA) block comprises on average 20 monomer units, on the assumption that the polymerization will be controlled. 3 g of solution of polyacrylic acid (PAA) 1st block, concentrated on a rotary evaporator to 85% of solid, is mixed with 7 g of vinylphosphonic acid (VPA), 4.6 g of water and 1.16 g of ethanol. 0.93 g of azobis(cyanopentanoic acid) (ACP) are added. The reaction is carried out at 70° C. After reacting for 6 hours, 0.93 g of azobis(cyanopentanoic acid) (ACP) is again added. The reaction is halted after 18 hours. The product is then analyzed by GPC.

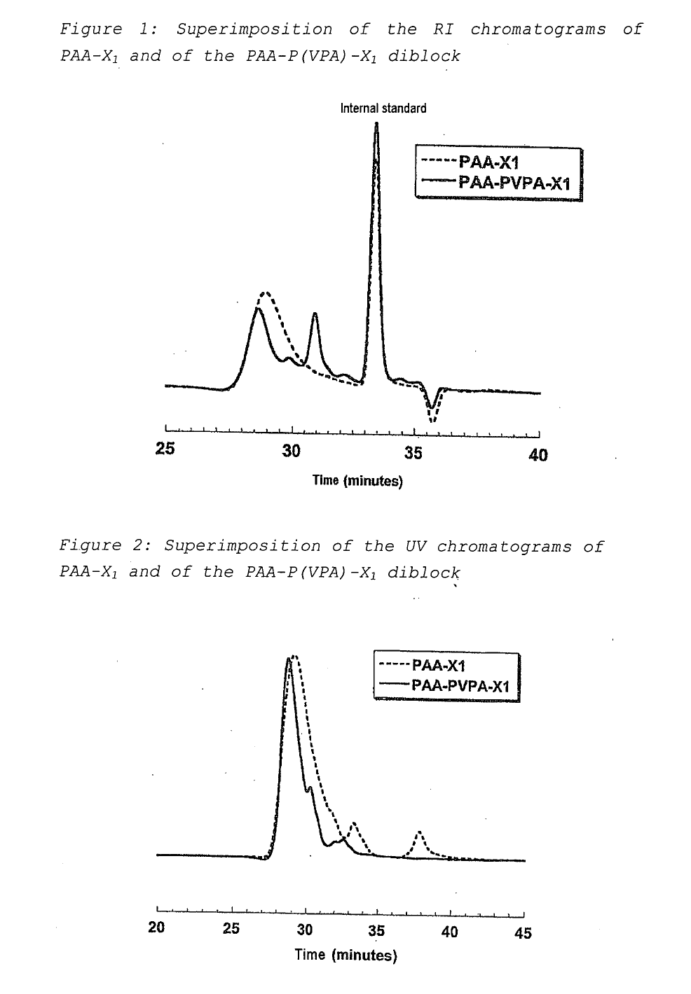

FIG. 1 shows the superimposition of the RI chromatograms of the first polyacrylic acid (PAA) block and of the final copolymer.

FIG. 2 is the analogue equipped with UV detection at 290 nm. In FIG. 1, it is possible to see, on the chromatogram, a peak characteristic of the presence of unconsumed vinylphosphonic acid (VPA) (˜31 min). In addition, the absence of multipopulation of polymer chains and the sliding of the peak weight between the first block and the final product are evidence that the diblock copolymer has indeed been obtained. This is corroborated by the results described in FIG. 2, which show, with regard to monomodal distributions, that the peak weight with regard to the population of living chains (UV) increases following the synthesis of the poly(vinylphosphonic acid) P(VPA) block.

1.-38. (canceled)

39. A controlled architecture copolymer comprising at least one block A obtained by the polymerization of a mixture of monomers possessing ethylenic unsaturation (A₀) not including monomers possessing vinylphosphonate functional groups and at least one block B obtained by the polymerization of a mixture of monomers possessing ethylenic unsaturation (B₀) comprising at least 50 mol % of at least one monomer B₁ bearing at least one vinylphosphonate functional group.

40. The copolymer as defined by claim 39, wherein the mixture of monomers A₀ comprises at least one monomer selected from the group consisting of the following hydrophilic (h) or hydrophobic (H) monomers:
from among the hydrophilic (h) monomers:
unsaturated ethylenic mono- and dicarboxylic acids, acrylic acid, methacrylic acid, itaconic acid, maleic acid or fumaric acid, and derivatives thereof, monoalkyl esters, amides, acrylamide or methacrylamide, or
ethylenic monomers comprising a ureido group, ethylene urea ethyl methacrylamide or ethylene urea ethyl methacrylate, or
ethylenic monomers comprising a sulfonic acid group or one of its alkali metal or ammonium salts, vinylsulfonic acid, vinylbenzenesulfonic acid, α-acrylamidomethylpropanesulfonic acid or 2-sulfoethylene methacrylate, or
monomers bearing a boronic acid functional group, p-vinylphenylboronic acid, or
cationic monomers selected from among aminoalkyl(meth)acrylates or aminoalkyl(meth)acrylamides; monomers comprising at least one secondary, tertiary or quaternary amine functional group or a heterocyclic group comprising a nitrogen atom; diallyldialkyl ammonium salts; or mixtures or salts thereof; dimethylamino-ethyl(meth)acrylate, dimethylaminopropyl(meth)acrylate, di(tert-butyl)aminoethyl(meth)acrylate, dimethylaminomethyl (meth)acrylamide, dimethylaminopropyl(meth)acrylamide; ethylenimine, vinylamine, 2-vinylpyridine, 4-vinylpyridine; trimethylammonioethyl(meth)acrylate chloride, trimethylammonioethyl acrylate methyl sulfate, benzyldimethylammonioethyl(meth)acrylate chloride, (4-benzoylbenzyl)dimethylammonioethyl acrylate chloride, trimethylammonioethyl(meth)acrylamide chloride, trimethyl(vinylbenzyl)ammonium chloride, diallyldimethylammonium chloride, or mixtures or salts thereof, or
cyclic amides of vinylamine, N-vinylpyrrolidone and vinylcaprolactam, or
the polyvinyl alcohol resulting from the hydrolysis of a polyvinyl acetate, or
hydrophilic polymers resulting from the chemical modification of a hydrophobic block, or
from among the hydrophobic (H) monomers:
monomers derived from styrene, styrene, α-methylstyrene, para-methylstyrene or para-(tert-butyl)styrene, or
esters of acrylic acid or of methacrylic acid with C₁-C₁₂ alcohols which are optionally fluorinated, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate, or
vinyl nitriles comprising from 3 to 12 carbon atoms, acrylonitrile or methacrylonitrile, or
vinyl esters of carboxylic acids, vinyl acetate, vinyl versatate or vinyl propionate, or
vinyl or vinylidene halides, vinyl chloride, vinylidene chloride and vinylidene fluoride, or
diene monomers, butadiene or isoprene.

41. The copolymer as defined by claim 39, wherein the mixture of monomers A₀ comprises at least one monomer selected from the group consisting of:
the following hydrophilic (h) monomers: acrylic acid (AA), acrylamide (Am), 2-acrylamido-2-methylpropanesulfonic acid (AMPS), styrenesulfonate (SS), N-vinylpyrrolidone, vinylsulfonic acid (VSA), vinyl alcohol units resulting from the hydrolysis of polyvinyl acetate, or mixtures thereof;
or from the following hydrophobic (H) monomers:
esters of acrylic acid with linear or branched C₁-C₈ alcohols, methyl acrylate, ethyl acrylate, propyl acrylate, butyl acrylate (BuA) or 2-ethylhexyl acrylate (2EHA), fluorinated acrylates, styrene derivatives, styrene, or vinyl acetate (VAc).

42. The copolymer as defined by claim 39, wherein the block A is a polyvinyl alcohol block or a polyacrylic acid block.

43. The copolymer as defined by claim 39, wherein the mixture of monomers A₀ comprises at least one monomer selected from the following monomers:
acrylic acid (AA) or acrylamide.

44. The copolymer as defined by claim 39, wherein the mixture B₀ comprises:
from 50 to 100 mol % of at least one monomer B₁ bearing a phosphonate functional group, and
from 0 to 50 mol % of at least one monomer B₂ selected from among the monomers (A₀).

45. The copolymer as defined by claim 39, wherein the monomer B₁ comprises a compound of formula (I): 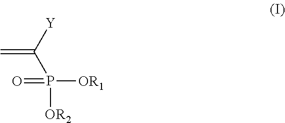
in which:
Y is a group selected from among a hydrogen atom, an alkyl radical having from 1 to 6 carbon atoms, a cyano, a phenyl radical, an ester radical of formula —COOR, an acetate radical of formula —OCOR′, a phosphonic acid or a phosphonic acid methyl, ethyl or isopropyl ester;
R and R′, which may be identical or different, are each an alkyl radical having from 1 to 12 carbon atoms;
R₁ and R₂, which may be identical or different, are each a hydrogen atom or an alkyl radical having from 1 to 6 carbon atoms which is optionally substituted by a halogen atom;
or mixtures thereof; with the proviso that, when Y is other than a hydrogen atom, then the block B also comprises monomers B₁ in which Y is a hydrogen atom.

46. The copolymer as defined by claim 39, wherein the monomer B₁ is selected from among vinylphosphonic acid, the dimethyl ester of vinylphosphonic acid, the bis(2-chloroethyl) ester of vinylphosphonic acid, vinylidenediphosphonic acid, the tetraisopropyl ester of vinylidenediphosphonic acid, α-styrenephosphonic acid or mixtures thereof.

47. The copolymer as defined by claim 39, wherein the monomer B₁ is in the free acid or salt form, or in the form partially or completely neutralized, optionally by an amine.

48. The copolymer as defined by claim 39, wherein the monomer B₁ comprises vinylphosphonic acid.

49. The copolymer as defined by claim 39, wherein the monomer B₂ is selected from among acrylic acid, acrylamide, vinylsulfonic acid or mixtures thereof.

50. The copolymer as defined by claim 39, wherein the monomer B₂ comprises acrylic acid.

51. The copolymer as defined by claim 39, having a weight-average molecular weight ranging from 1,000 to 100,000 and a polydispersity index ranging from 1.3 to 2.5.

52. The copolymer as defined by claim 39, wherein the ratio of the block A to the block B ranges from 1/99 to 99/1.

53. A process for the synthesis of a controlled architecture copolymer comprising at least one block A obtained by the polymerization of a mixture of monomers possessing ethylenic unsaturation (A₀) not including monomers possessing vinylphosphonate functional groups and at least one block B obtained by the polymerization of a mixture of monomers possessing ethylenic unsaturation (B₀) comprising at least 50 mol % of at least one monomer B₁ carrying at least one vinylphosphonate functional group, comprising the following stages:
(a) a controlled radical polymerization is carried out, resulting in the production of a functionalized polymer useful as a control agent in a controlled radical polymerization reaction, said stage being carried out by bringing into contact:
ethylenically unsaturated monomer molecules,
a source of free radicals, and
at least one control agent;
(b) following stage (a), a stage of controlled radical polymerization or several successive stages of controlled radical polymerizations is/are carried out, said stage(s) each entailing carrying out a controlled radical polymerization resulting in the production of a functionalized block copolymer useful as a control agent in a controlled radical polymerization reaction, said stage or stages being carried out by bringing into contact:
ethylenically unsaturated monomer molecules different from those employed in the preceding stage,
a source of free radicals, and
the functionalized polymer resulting from the preceding stage,
with the proviso that one of the polymerization stages (a) and (b) defined above results in the formation of the block B, the block comprising the vinylphosphonate functional groups, and that another of the polymerization stages of stages (a) and (b) results in the formation of another block, the block A,
the ethylenically unsaturated monomers employed in stages (a) and (b) being selected from appropriate monomers to obtain a controlled architecture copolymer as defined above, and further wherein:
the concentration of monomer B₀ in the medium is such that the level of solids is greater than 50%, the level of solids being defined as follows:
weight B₀/weight (B₀+solvent), if B₀ is polymerized as first block,
weight (A₀+B₀)/weight (A₀+B₀+solvent), if B₀ is polymerized as second block; and
the cumulative or total concentration of the initiator ranges from 0.5 to 20 mol % with respect to the mixture of monomers B₀.

54. The process as defined by claim 53, wherein the control agent comprises a thiocarbonylthio compound RS(C═S)Z.

55. The process as defined by claim 53, wherein the control agent is selected from among the dithioesters, thioethers-thiones, trithiocarbonates, dithiocarbamates, N,N-dialkyldithiocarbamates, dithiocarbazates and xanthates,

56. The process as defined by claim 53, wherein the control agent is selected from among the N,N-dialkyldithiocarbamates, dithiocarbazates or xanthates.

57. The process as defined by claim 53, wherein the control agent is selected from among the xanthates.

58. The process as defined by claim 53, wherein the control agent comprises a compound of following formula (II): 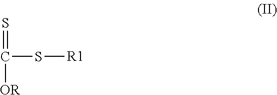
in which:
R is:
H or Cl;
an alkyl, aryl, alkenyl or alkynyl radical;
a saturated or unsaturated, optionally aromatic, carbon ring;
a saturated or unsaturated, optionally aromatic, heterocycle;
an alkylthio group;
an alkoxycarbonyl, aryloxycarbonyl, carboxyl, acyloxy or carbamoyl group;
a cyano, dialkyl- or diarylphosphonato, or dialkyl- or diarylphosphinato group;
a polymer chain;
an (R₂)O— or (R₂)(R′₂)N— group in which the R₂ and R′₂ radicals, which may be identical or different, each represent:
an alkyl, acyl, aryl, alkenyl or alkynyl radical;
a saturated or unsaturated, optionally aromatic, carbon ring; or
a saturated or unsaturated, optionally aromatic, heterocycle; and
R1 is:
an alkyl, acyl, aryl, alkenyl or alkynyl radical;
a saturated or unsaturated, optionally aromatic, carbon ring;
a saturated or unsaturated, optionally aromatic, heterocycle; or
a polymer chain.

59. The process as defined by claim 58, wherein the control agent is a compound of formula (II) in which R is an ethyl radical and R1 is a (methoxycarbonyl)ethyl radical.

60. The process as defined by claim 53, wherein the mixture of monomers A₀ comprises at least one monomer selected from the group consisting of the following hydrophilic (h) or hydrophobic (H) monomers: from among the hydrophilic (h) monomers:
unsaturated ethylenic mono- and dicarboxylic acids, acrylic acid, methacrylic acid, itaconic acid, maleic acid or fumaric acid, and derivatives thereof, monoalkyl esters, amides, acrylamide or methacrylamide, or
ethylenic monomers comprising a ureido group, ethylene urea ethyl methacrylamide or ethylene urea ethyl methacrylate, or
ethylenic monomers comprising a sulfonic acid group or one of its alkali metal or ammonium salts, vinylsulfonic acid, vinylbenzenesulfonic acid, α-acrylamidomethylpropanesulfonic acid or 2-sulfoethylene methacrylate, or
monomers bearing a boronic acid functional group, p-vinylphenylboronic acid, or
cationic monomers selected from among aminoalkyl(meth)acrylates or aminoalkyl(meth)acrylamides; monomers comprising at least one secondary, tertiary or quaternary amine functional group or a heterocyclic group comprising a nitrogen atom; diallyldialkyl ammonium salts; or mixtures or salts thereof; dimethylamino-ethyl(meth)acrylate, dimethylaminopropyl(meth)acrylate, di(tert-butyl)aminoethyl(meth)acrylate, dimethylaminomethyl(meth)acrylamide, dimethylaminopropyl(meth)acrylamide; ethylenimine, vinylamine, 2-vinylpyridine, 4-vinylpyridine; trimethylammonioethyl(meth)acrylate chloride, trimethylammonioethyl acrylate methyl sulfate, benzyldimethylammonioethyl(meth)acrylate chloride, (4-benzoylbenzyl)dimethylammonioethyl acrylate chloride, trimethylammonioethyl(meth)acrylamide chloride, trimethyl(vinylbenzyl)ammonium chloride, diallyldimethylammonium chloride, or mixtures or salts thereof, or
cyclic amides of vinylamine, N-vinylpyrrolidone and vinylcaprolactam, or
the polyvinyl alcohol resulting from the hydrolysis of a polyvinyl acetate, or
hydrophilic polymers resulting from the chemical modification of a hydrophobic block, or
from among the hydrophobic (H) monomers:
monomers derived from styrene, styrene, α-methylstyrene, para-methylstyrene or para-(tert-butyl)styrene, or
esters of acrylic acid or of methacrylic acid with C₁-C₁₂ alcohols which are optionally fluorinated, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate, or
vinyl nitriles comprising from 3 to 12 carbon atoms, acrylonitrile or methacrylonitrile, or
vinyl esters of carboxylic acids, vinyl acetate, vinyl versatate or vinyl propionate, or
vinyl or vinylidene halides, vinyl chloride, vinylidene chloride and vinylidene fluoride, or
diene monomers, butadiene or isoprene.

61. The process as defined by claim 53, wherein the mixture of monomers A₀ comprises at least one monomer selected from the group consisting of:
the following hydrophilic (h) monomers:
acrylic acid (AA), acrylamide (Am), 2-acrylamido-2-methylpropanesulfonic acid (AMPS), styrenesulfonate (SS), N-vinylpyrrolidone, vinylsulfonic acid (VSA), vinyl alcohol units resulting from the hydrolysis of polyvinyl acetate, or mixtures thereof;
or from the following hydrophobic (H) monomers:
esters of acrylic acid with linear or branched C₁-C₈ alcohols, methyl acrylate, ethyl acrylate, propyl acrylate, butyl acrylate (BuA) or 2-ethylhexyl acrylate (2EHA), or styrene derivatives, styrene, or fluorinated acrylates, or vinyl acetate (VAc).

62. The process as defined by claim 53, wherein the mixture of monomers A₀ comprises at least one monomer selected from among the following monomers:
acrylic acid (AA) or acrylamide.

63. The process as defined by claim 53, wherein the mixture B₀ comprises:
from 50 to 100 mol % of at least one monomer B₁ bearing a phosphonate functional group, and
from 0 to 50 mol % of at least one monomer B₂ selected from among the monomers (A₀).

64. The process as defined by claim 53, wherein the monomer B₁ comprises a compound of formula (I): 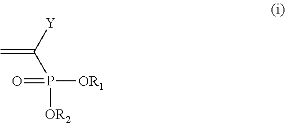
in which:
Y is a group selected from among a hydrogen atom, an alkyl radical having from 1 to 6 carbon atoms, a cyano, a phenyl radical, an ester radical of formula —COOR, an acetate radical of formula —OCOR′, a phosphonic acid or a phosphonic acid methyl, ethyl or isopropyl ester;
R and R′, which may be identical or different, are each an alkyl radical having from 1 to 12 carbon atoms;
R₁ and R₂, which may be identical or different, are each a hydrogen atom or an alkyl radical having from 1 to 6 carbon atoms which is optionally substituted by a halogen atom;
or mixtures thereof; with the proviso that, when Y is other than a hydrogen atom, then the block B also comprises monomers B₁ in which Y is a hydrogen atom.

65. The process as defined by claim 53, wherein the monomer B₁ is selected from among vinylphosphonic acid, the dimethyl ester of vinylphosphonic acid, the bis(2-chloroethyl) ester of vinylphosphonic acid, vinylidenediphosphonic acid, the tetraisopropyl ester of vinylidenediphosphonic acid, α-styrenephosphonic acid or mixtures thereof.

66. The process as defined by claim 53, wherein the monomer B₁ is in the free acid or salt form, or in the form partially or completely neutralized, optionally by an amine.

67. The process as defined by claim 53, wherein the monomer B₁ comprises vinylphosphonic acid.

68. The process as defined by claim 53, wherein the monomer B₂ is selected from among acrylic acid, acrylamide, vinylsulfonic acid or mixtures thereof.

69. The process as defined by claim 53, wherein the monomer B₂ comprises acrylic acid.

70. The process as defined by claim 53, wherein the polymerization is carried out under bulk conditions, in a solvent, a water-alcohol mixture, or in a dispersed medium.

71. The process as defined by claim 70, carried out in ethyl acetate, ethanol, isopropanol, or mixtures thereof with water.

72. A scale inhibitor comprising the copolymer as defined by claim 39.

73. A dispersant comprising the copolymer as defined by claim 39.

74. An emulsifier comprising the copolymer as defined by claim 39.

75. An inorganic surface modifier comprising the copolymer as defined by claim 39.

76. A corrosion inhibitor comprising the copolymer as defined by claim 39.
